(19) United States
(12) Patent Application Publication
(10) Pub. No.: US 2011/0273147 A1
(43) Pub. Date: Nov. 10, 2011

(54) Electric Tap in a Voltage Regulator Circuit

(76) Inventors: David R. Hall, Provo, UT (US); Kevin Rees, Provo, UT (US); Jim Shumway, Lehi, UT (US); David Wahlquist, Spanish Fork, UT (US)

(21) Appl. No.: 12/773,609

(22) Filed: May 4, 2010

(51) Int. Cl. H02H 7/06

(52) U.S. Cl. 322/28

(57) ABSTRACT

In one aspect of the present invention, a voltage regulator circuit comprises at least one coil disposed around a rotor coupled to a first rectifier. The coil comprises an electric tap connected to a second rectifier. The first rectifier and second rectifier are coupled to each other with at least one switch. The second rectifier is connected to a common load and the first rectifier is connected to the load via the at least one switch.

### BACKGROUND OF THE INVENTION

The present invention relates to the field of power generation through generators.

U.S. Pat. No. 6,278,266 to Glasband, which is herein incorporated by reference for all that it contains, discloses a power generator and method of use for providing symmetrical power. In the present invention, the output winding of a generator is center-tapped at the point of mean voltage differential between each of its two output terminals. The center tap is grounded such that one-half of the output potential appears across each half of the output winding. Full, symmetrical voltage is applied to the load when the output terminals are connected to the load and the load is grounded.

U.S. Pat. No. 4,138,634 to Yukawa, which is herein incorporated by reference for all that it contains, discloses an automatic voltage regulator for an excited AC generator comprising at least one controlled rectifier for conducting the field current of the generator, a trigger signal supplying means for supplying a trigger signal to the controlled rectifier when the controlled rectifier is forward biased, a voltage detection circuit for detecting the output voltage of the generator, an inhibiting circuit for inhibiting turn-on of the controlled rectifier when the instantaneous value of the voltage detection circuit exceeds a predetermined voltage, characterized in that the voltage detection circuit comprises a phase shifting circuit receiving and shifting the phase of the output voltage of the generator. The amount of phase shift may be selected so that the inhibiting operation terminates and hence the turn-on of the controlled rectifier is affected at any angle within a wide range to adjust to the load being energized.

U.S. Pat. No. 4,985,670 to Kaneyuki, which is herein incorporated by reference for all that it contains, discloses a voltage regulator circuit for an AC generator having two distinct DC output voltage levels, which comprises a full-wave rectifier circuit for rectifying the AC voltages induced in the armature winding of the generator, and a change-over switch which selectively couples the battery and a high voltage load across the output terminals of the rectifier circuit, the negative output terminal of which is grounded. Further, a serial connection of three resistors is coupled across the positive terminal of the rectifier circuit and ground and a rectifier diode is coupled across the positive terminal of the field winding and a junction between the intermediate resistor and the extreme resistor coupled to the positive terminal of the rectifier circuit, the forward direction of the diode being directed from the positive to the negative terminal of the battery in the serial circuit formed by the diode, the intermediate resistor, and the other extreme resistor. The junction between the last named two resistors is coupled to a Zener diode through another rectifier diode, which Zener diode controls the switching of transistors regulating the flow of the field current supplied from the battery. A further serial circuit of two resistors is directly coupled across the battery, the junction being coupled to the Zener diode through still another rectifier diode. The resistors and rectifier diodes constituted a voltage divider circuit which automatically regulates the output voltage of the rectifier circuit to a lower and a higher level according to the position of the change-over switch.

Other references from the prior art include U.S. Pat. No. 6,703,718 to Calley et al., U.S. Pat. No. 3,899,731 to Smith, which are all herein incorporated by reference for all they contain.

### BRIEF SUMMARY OF THE INVENTION

In one aspect of the present invention, a voltage regulator circuit comprises at least one coil disposed around a rotor coupled to a first rectifier. The coil comprises an electric tap connected to a second rectifier. The first rectifier and second rectifier are coupled to each other with at least one switch. The second rectifier is connected to a common load and the first rectifier is connected to the load via the at least one switch.

The voltage regulator circuit is a generator. The generator may be a multiple phase generator. The rotor may comprise a magnet. Each of the coils in the multiple phase generators may be connected to the electrical tap. The electrical tap may connect the coils of the multiple phase generator at different lengths measured from a junction of the coils. The electrical tap may electrically connect to all the phases at a junction of the phases. The generator may be an alternator. The generator may also be an induction generator. A second electrical tap may connect the coil to a third rectifier; the third rectifier being in electrical communication with the load via another electrical switch. The voltage regulator circuit may be a motor. Any of the electrical taps may comprise a center tap.

In another aspect of the invention, a turbine driven voltage regulator circuit comprises at least one coil disposed around a rotor coupled to a first rectifier. The rotor is in mechanical communication with a turbine. The coil comprises an electric tap connected to a second rectifier. The first rectifier and second rectifier are coupled to each other with at least one switch. The second rectifier is connected to a common load, and the first rectifier is connected to the load via the at least one switch. The turbine may be a drilling fluid driven turbine disposed within a bore of a downhole tool string. The turbine may be incorporated into a wind mill. The turbine may also be incorporated into a hydroelectric plant.

In yet another aspect of the invention, an apparatus for controlling voltage comprises at least one coil disposed around a rotor coupled to a first rectifier. The rotor is in mechanical communication with a tire assembly. The coil comprises an electric tap connected to a second rectifier. The first rectifier and second rectifier are coupled to each other with at least one switch. The second rectifier is connected to a common load, and the first rectifier is connected to the load via the at least one switch. The rotor may also be in mechanical communication with an engine assembly. The apparatus may be incorporated into a braking system. The braking system may comprise a regenerative braking system.

### BRIEF DESCRIPTION OF THE DRAWINGS

FIG. 1 is a perspective diagram of an embodiment of a drill string assembly suspended in a bore hole.

FIG. 2 is a perspective diagram of an embodiment of a three phase generator assembly with a turbine suspended in a bore hole.

FIG. 3a is a schematic diagram of an embodiment of a three phase generator assembly.

FIG. 3b is a diagram of an embodiment of a graph.

FIG. 4a is a schematic diagram of another embodiment of a three phase generator assembly.

FIG. 4b is a diagram of another embodiment of a graph FIG. 5a is a schematic diagram of another embodiment of a three phase generator assembly.

FIG. 5b is a diagram of another embodiment of a graph.

FIG. 6 is a schematic diagram of another embodiment of a three phase generator assembly.

FIG. 7 is a schematic diagram of another embodiment of a three phase generator assembly.

FIG. 8a is a schematic diagram of an embodiment of a single phase generator assembly.

FIG. 8b is a schematic diagram of an embodiment of a four phase generator assembly.

FIG. 9 is a schematic diagram of another embodiment of three phase generator assembly.

FIG. 10 is a perspective diagram of an embodiment of a wind turbine assembly.

FIG. 11 is a perspective diagram of an embodiment of a three phase generator assembly connected to a tire assembly.

FIG. 12 is a perspective diagram of an embodiment of a hydroelectric plant.

### DETAILED DESCRIPTION OF THE INVENTION AND THE PREFERRED EMBODIMENT

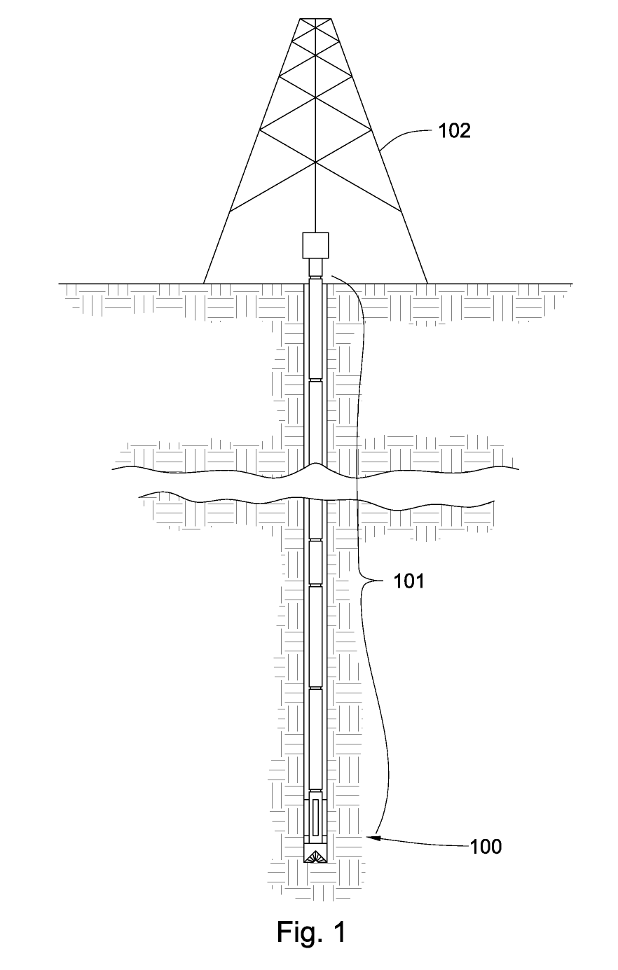

FIG. 1 is a perspective diagram of an embodiment of a drill string 100 suspended by a derrick 101. A bottom-hole assembly 102 is located at the bottom of a wellbore 103 and comprises a drill bit 104. As the drill bit 104 rotates down hole the drill string 100 advances further into the earth. The drill string 100 may penetrate soft or hard subterranean formations 105. The drill bit 104 may break up the formations 105 by cutting and/or chipping the formation 105 during a down hole drilling operation. The bottom-hole assembly 102 and/or down hole components may comprise data acquisition devices which may gather data. The data may be sent to the surface via a transmission system to a data swivel 106. The data swivel 106 may send the data to the surface equipment. Further, the surface equipment may send data and/or power to down hole tools and/or the bottom-hole assembly 102. In some embodiments of the present invention, no telemetry is incorporated in the drill string. The drill string may be used in oil and gas, construction and mining, geothermal, and/or horizontal drilling applications.

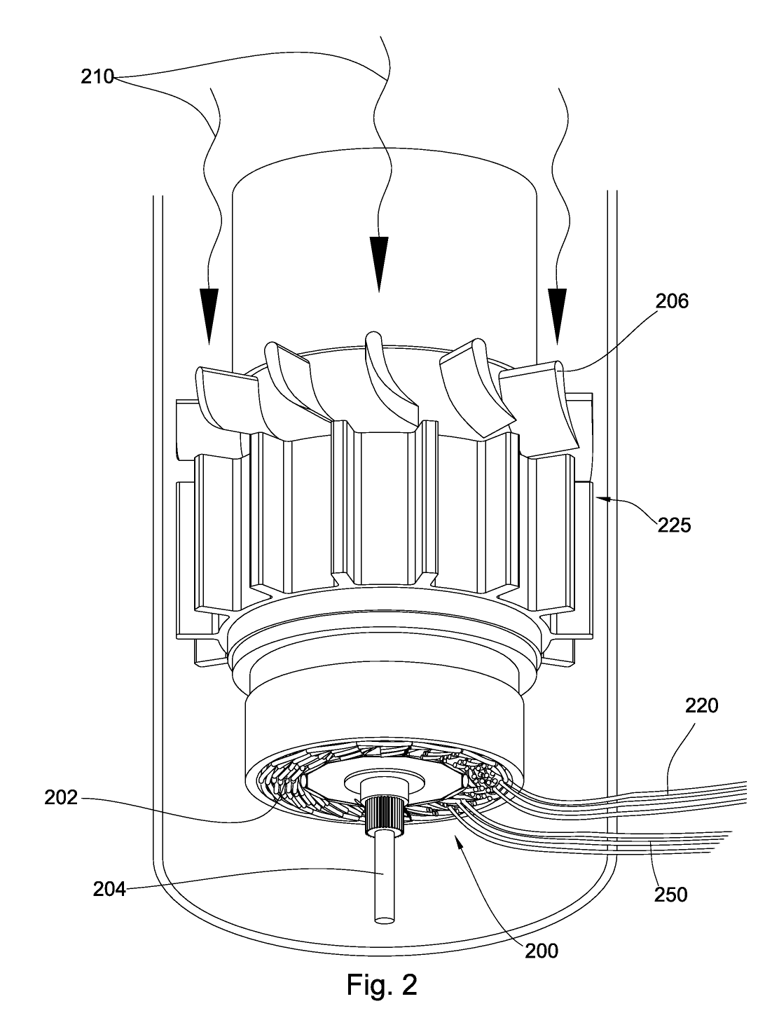

Referring to FIG. 2, discloses a multiple phase generator 200 disposed within a bore 225 of the downhole drill string 100. The generator 200 may comprise coils of wire 202 wound up in a particular configuration. The coils of wire 202 may comprise copper or other electrically conductive materials suitable for power generation. As drilling mud (represented by arrows 210) flows engages a turbine 206, also positioned within the bore, a rotor 204 of the generator is also rotated. The rotor contains a magnet and during the rotor's rotation, the magnetic field of the magnet induces an alternating current in the wires 202. Two sets 220, 250 of wires may come off the coils of wire. One set 220 may be in electrical communication with generator phases, while the other set 250 is also in communication with an internal wire tap to the phases.

While a three phase generator is shown in most of the proceeding figures, various kinds of generators or motors may be compatible with the present invention, namely single phase generators, induction generators, alternators, induction motors, and multiple phase generators.

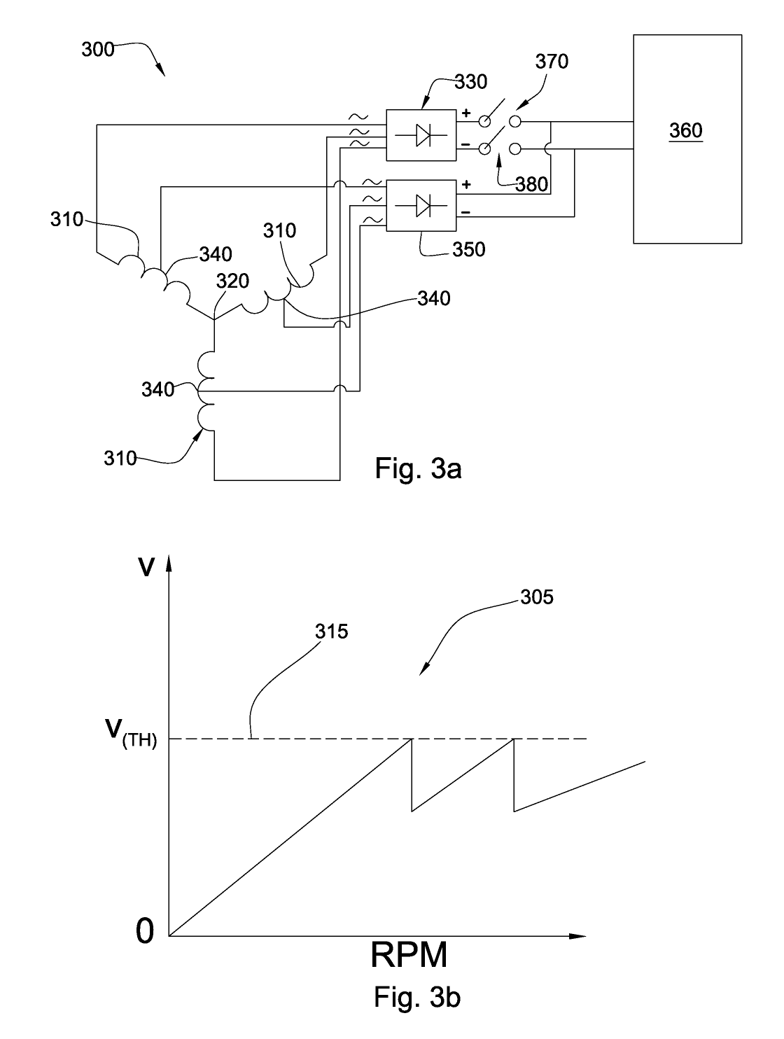

FIG. 3a is a schematic diagram of an embodiment of a three phase generator assembly 300. The generator assembly 300 may comprise three coils of wire 310. Each coil of wire 310 may comprise a first end and a second end. The first ends of each coil of wire 310 are coupled to each other at a common junction 320. The second ends of each coil of wire 310 are coupled to a first rectifier 330. Each coil 310 may be connected to an electrical tap 340. The electrical taps 340 may connect the coils of wire 310 at different or at the same distances, as measured from the junction 320 of wires. Any of the electrical taps may be a center tap. Each electrical tap 340 is coupled to a second rectifier 350. The first and second rectifiers may be full wave rectifiers. The first rectifier 330 and second rectifier 350 comprise positive and negative terminals. The terminals of the second rectifier 350 are directly connected to a load 360. The terminals of the first rectifier 330 may be connected to the load 360 via a first switch 370 and a second switch 380. The load 360 may receive a maximum voltage when both the first switch 370 and second switch 380 are closed. The voltage may drop when either the first switch 370 or second switch 380 is opened. The load 360 may receive a minimum voltage when both the first switch 370 and second switch 380 are opened.

FIG. 3b shows a graph 305 of an output voltage of a generator vs. rpm of the rotor. The graph 305 is in reference to the voltage regulator circuit in FIG. 3a. There is a positive relationship with the voltage output and the rpm of the rotor. As the rotor increases in speed, so does the voltage output.

Logic gates or discrete components may be used to sense the output voltage and drop the voltage, by opening the switches, before a threshold output voltage 315 is reached. The threshold voltage may be any voltage that is undesirable to exceed. In some embodiments, the threshold voltage may be reached when the load receives so much voltage that the load risks overheating. In embodiments where a generator is positioned in a downhole tool string, the rpm will be affected by the drilling mud's flow. Some downhole applications may call for flow higher than ideal for the generator's output. Controlling the voltage gives greater flexibility to drilling operators, who can be less concerned about how the flow will impact the downhole generator powered electronics. The downhole environment can also be extremely hot contributing to heating the load. Reducing a voltage output in hotter environments may also prevent downhole electronics from overheating.

Either the first switch 370 or second switch 380 may open when the voltage approaches closer to the threshold voltage 315 with increasing rpm, thereby resulting in a voltage drop. If the rpm continues to increase such that the output voltage again approaches the threshold voltage, the other switch may be opened to further drop the voltage.

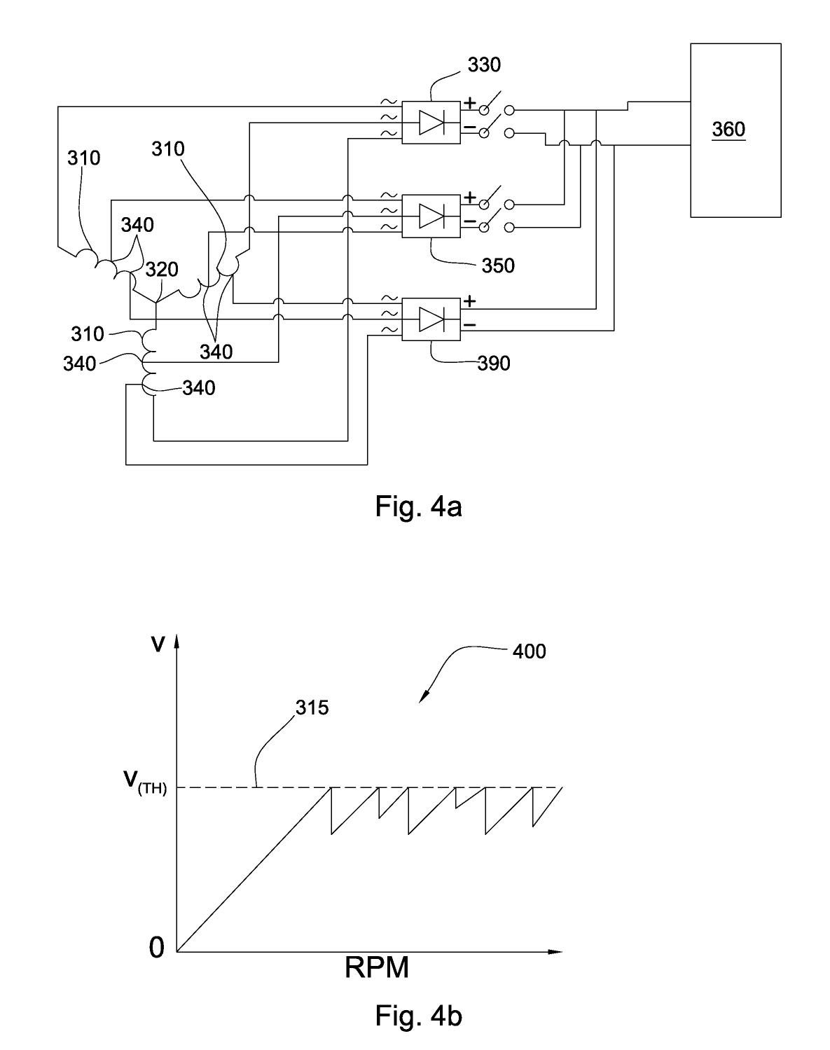

Referring now to FIG. 4a, the voltage regulator circuit may comprise multiple electrical taps 340 in each coil of wire 310. The taps may be spaced at the same or at different distances as measured from the common junction 320 of coils 310. The additional electric taps may each be electrically connected to an additional rectifier. In the embodiment shown the phases are connected to a third rectifier 390. The terminals of the third rectifier 390 are directly connected to the load 360. The terminals of the first rectifier 330 and second rectifier 350 are connected to the load 360 via switches. As the output voltage is desired to be dropped, any of the switches may be opened in any order. Factors, such as the number of electric taps, the number of phases, and the distances at which the each of the taps are electrically connected to the phases and which switches are open, will determine how large the voltage drop will be for opening a particular switch. In some applications, these combinations of factors can be fine tuned to achieve optimal voltage output results for the specific application.

The graph 400 of FIG. 4b refers to the voltage regulator circuit in FIG. 4a. The graph 400 discloses multiple voltage drops. The magnitude and number of voltage drops is usually inconsistent as shown, depending on the position of the electric taps and which particular switches are opened.

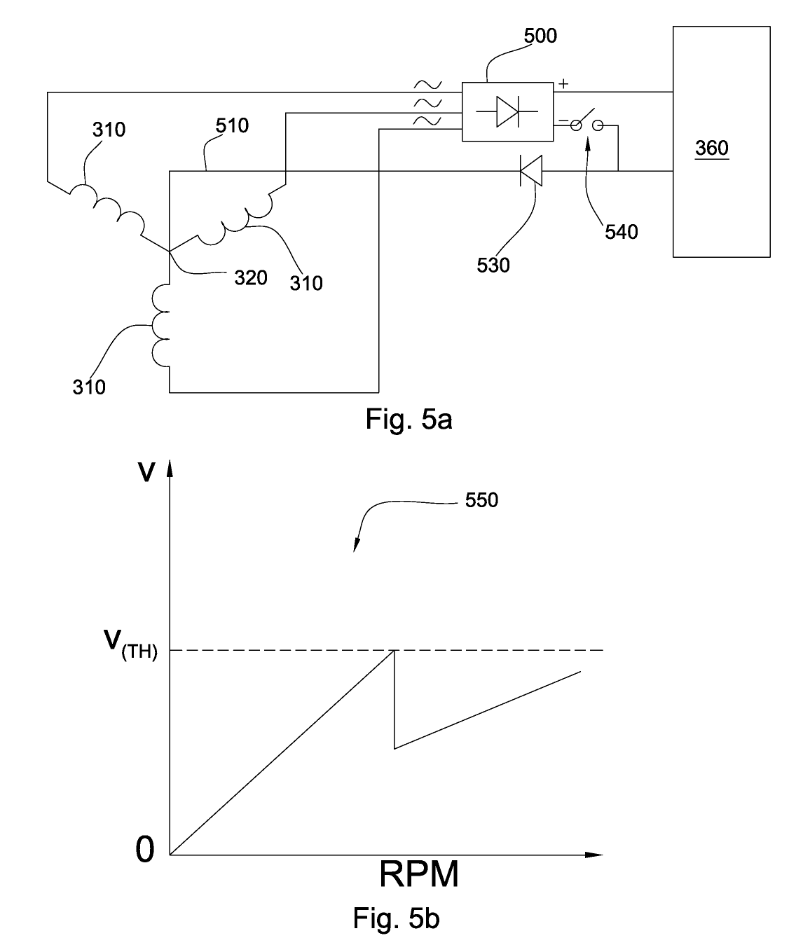

Referring to FIG. 5a, a diagram of another embodiment of a voltage regulator circuit is disclosed. The voltage regulator circuit comprises three coils of wire 310. One end of each wire 310 is coupled to a common junction 320 of wires 310 while the other end is coupled to a rectifier 500. The voltage regulator circuit comprises an additional wire 510. One end of the additional wire 510 is coupled to the common junction 320 of the three coils of wire 310 whereas the other end is coupled to the load 360 via a diode 530. The terminals of the rectifier 500 comprise a switch 540. A maximum voltage is supplied to the load 360 when the switch 540 is closed. When the switch 540 is open, the supplied voltage may be almost 60 percent of the maximum voltage. The diode 530 in the circuit completes the current path when the switch 540 is open.

FIG. 5b is an embodiment of a graph 550 referring to the circuit in FIG. 5a. The voltage regulator circuit comprises two different voltages supplied to the load 360. The voltage drop in this embodiment is relatively higher than the other embodiments.

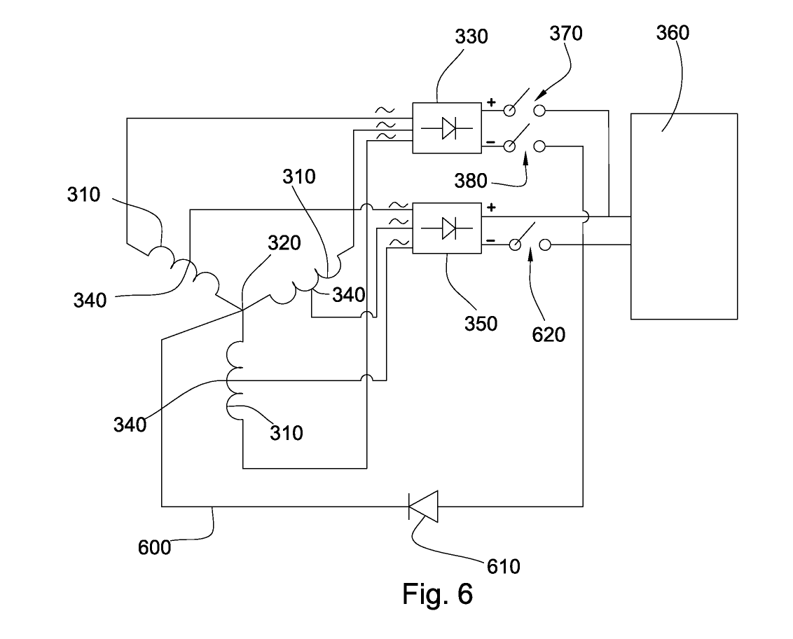

Referring now to FIG. 6, a schematic diagram of another embodiment of a voltage regulator circuit is disclosed. The circuit comprises three coils of wire 310 and an additional wire 600. One end of the three coils of wire 310 and the additional wire 600 is coupled to the common junction 320 of three coils of wire 310 and a diode 610, while the other ends are coupled to a first rectifier 330. The three coils of wire 310 are coupled to electrical taps 340. The electric taps 340 are coupled to a second rectifier 350. The terminals of the first rectifier 350 comprise two switches 370, 380. The terminals of the second rectifier 330 comprise a switch 620. This embodiment may allow eight different variations in the switch connections, providing various voltages supplied to the load 360.

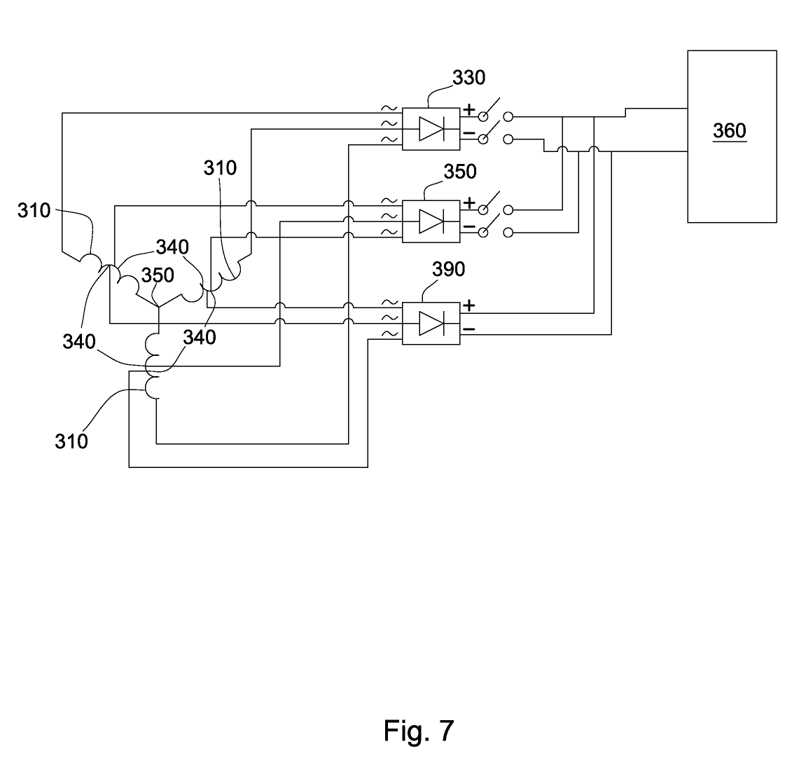

Referring now to FIG. 7, a schematic diagram of another embodiment of a voltage regulator circuit is disclosed. The circuit comprises three coils of wires 310. The coils 310 are coupled to multiple electrical taps 340. The electrical taps 340 are within the same winding of the coils 310. The terminals of the first rectifier 350 and the third rectifier 390 may comprise a minimum voltage difference.

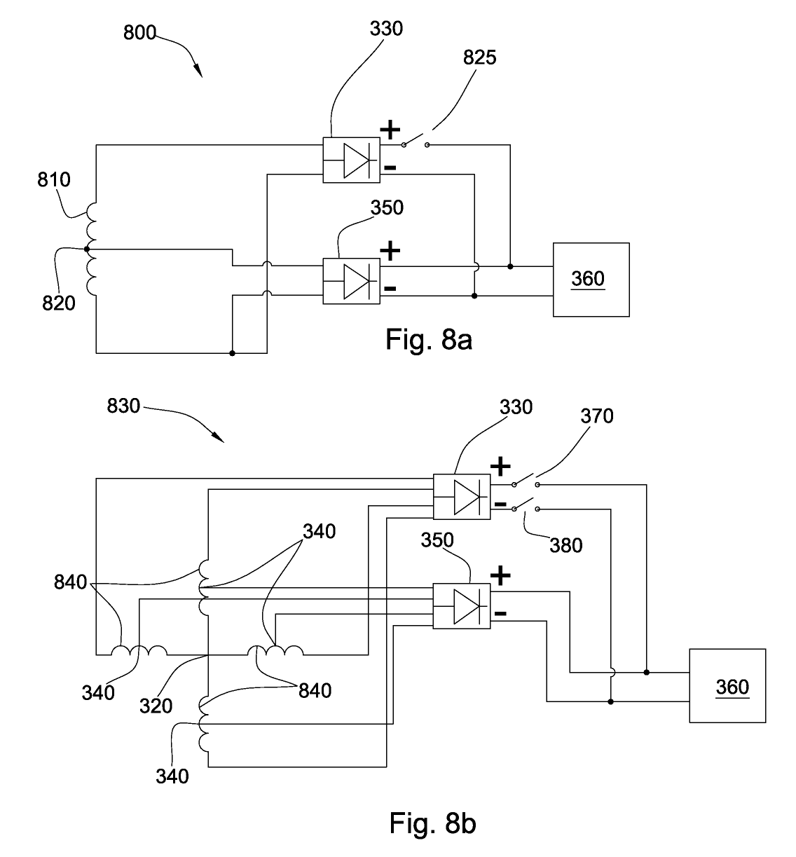

FIG. 8a is a schematic diagram of an embodiment of a single phase generator 800. The circuit may comprise a single coil of wire 810. The coil 810 is connected to an electrical tap 820. The ends of the coil 810 and the electrical tap 820 are coupled to a first rectifier 330 and a second rectifier 350 respectively. The terminals of the second rectifier 330 may comprise a switch 825. The terminals of the second rectifier 350 are directly connected to the load 360.

FIG. 8b is a schematic diagram of an embodiment of a four phase generator 830. The circuit may comprise four coils of wire 840. One end of each coil 840 is connected to a common junction 320 of coils 840 while the other end is connected to a first rectifier 330. Each coil 840 is connected to an electrical tap 340, and the ends of electrical taps 340 are coupled to a second rectifier 350. The terminals of the first rectifier 330 are connected to the load 360 via two switches 370 & 380. The terminals of the second rectifier 350 are directly connected to the load 360. The opening and closing of the switches 370 & 380 may cause variation in the voltage supplied to the load 360.

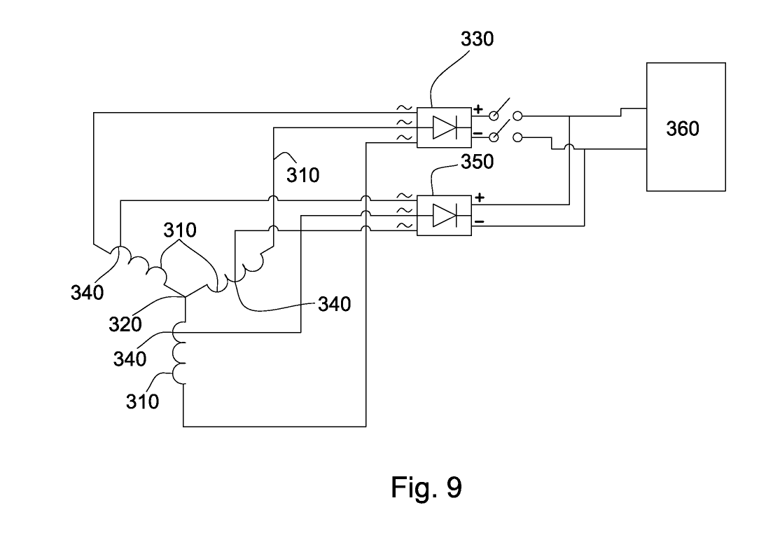

Referring to FIG. 9, a schematic diagram of another embodiment of a voltage regulator circuit is shown. The circuit comprises three coils of wire 310. One end of each coil 310 is connected to a common junction 320 while the other end is connected to the first rectifier 330. The coils 310 are connected to electrical taps 340. The electrical taps 340 are coupled to the second rectifier 350. Each electrical tap 340 may be connected at different windings within the coils of wire 310. In this embodiment, the voltage supplied to the load 360 may comprise variation depending on the position of the switches and the position of the electrical taps 340.

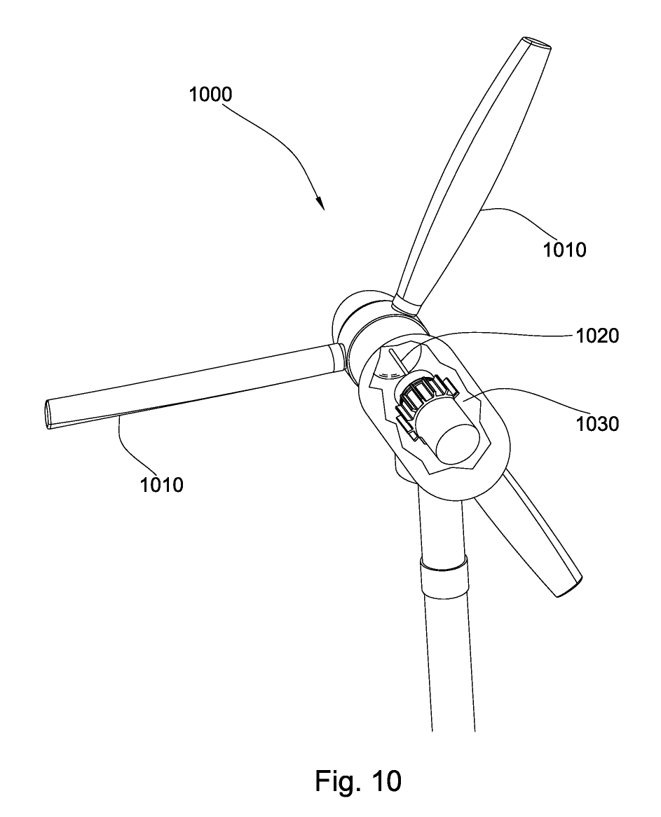

Referring now to FIG. 10, the voltage regulator circuit may be incorporated into a windmill 1000. The windmill 1000 comprises blades 1010, which are connected to a rotor in the generator 1030 by a shaft 1020. The rotation of the blades 1010 by wind rotates the rotor, thereby inducing an oscillating magnetic field. The oscillating magnetic field induces an alternating current in the coils of wire in the generator 1030. It may be advantageous to incorporate the voltage regulator in a wind mill because the wind is variable, during severe storms, microbursts, tornado, etc, the windmills blade may cause output voltage to drastically increase. The present embodiment may prevent or reduce damage in these situations. It may also be desirable to regulate the output voltage in windmills absent severe weather.

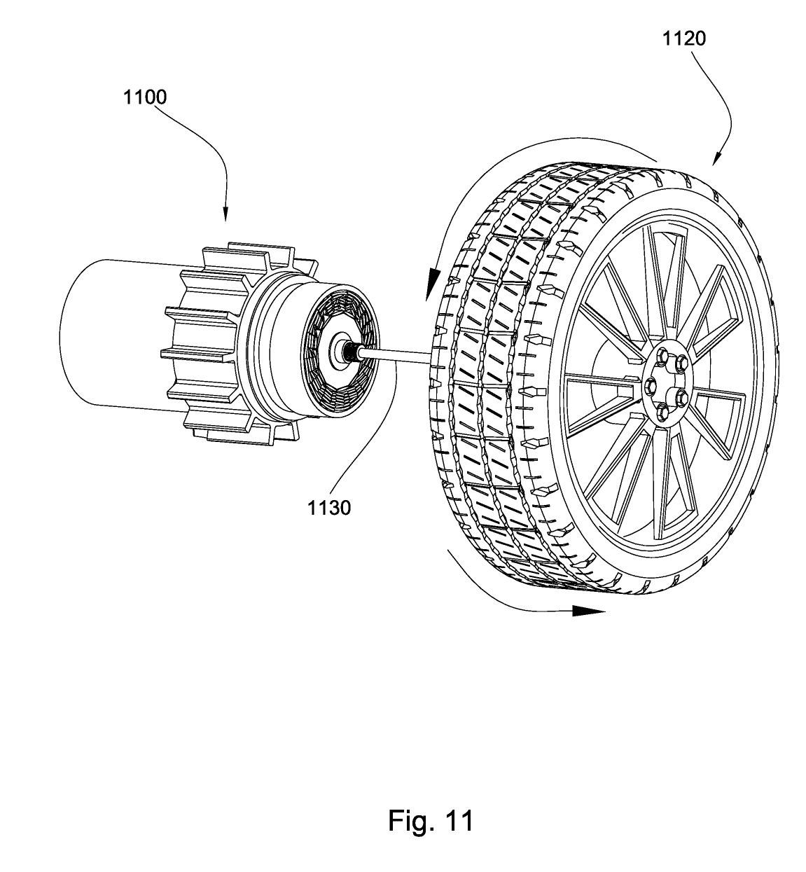

Referring now to FIG. 11, the voltage regulator circuit may be incorporated into a braking system. The braking system may comprise a regenerative braking system. The regenerative braking system may comprise at least one motor-generator 1100. The motor-generator 1100 may comprise a rotor. The rotor may be in mechanical communication with a tire assembly 1120 by a shaft 1130. The rotor may also be in mechanical communication with an engine assembly. The regenerative braking system captures a vehicle's kinetic energy to slow the vehicle by producing magnetic friction, which is used to recharge a battery. When the brake is applied, an onboard computer stops drawing power from the battery and instead directs power to the battery. The generator 1100 simultaneously stops receiving electricity for powering the vehicle and starts sending current back to the battery for charging. The present invention may be used to regulate the voltage output as described above.

The voltage regulator circuit may also function as a motor. Energy from the battery may be applied to the coil windings to turn the tire assembly. The present invention may control the torque produced on the tire assembly, thereby controlling its speed. In some embodiments, it may be used in ways similar to a clutch. This may be applied to propellers, tires, jet engines, or combinations thereof.

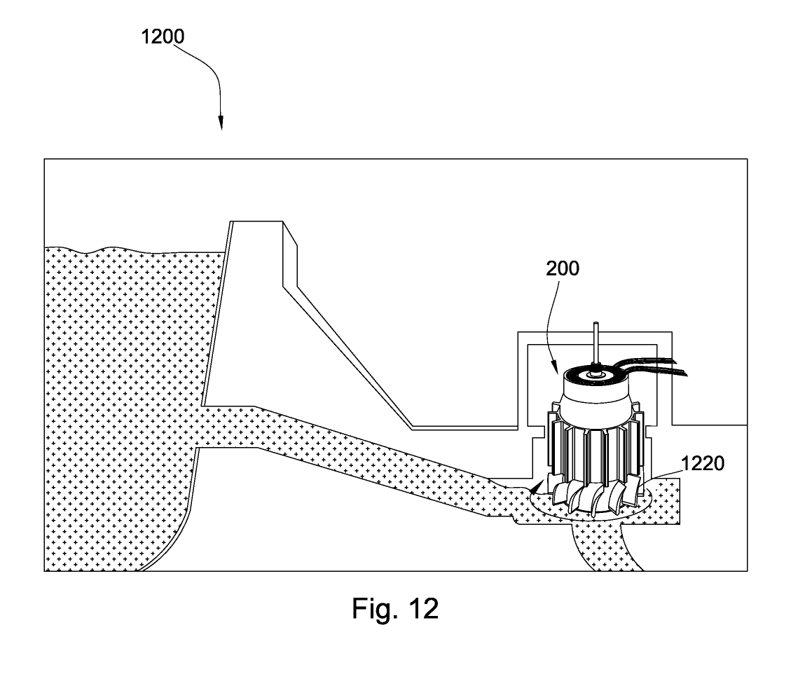

Referring now to FIG. 12, the voltage regulator circuit may be incorporated into a hydroelectric plant 1200. The hydroelectric plant 1200 comprises a turbine 1220 and generator. The turbine's rotation is controlled by the water flow and produces alternating current. The produced electricity may be regulated by utilizing the present invention.

Whereas the present invention has been described in particular relation to the drawings attached hereto, it should be understood that other and further modifications apart from those shown or suggested herein, may be made within the scope and spirit of the present invention.

What is claimed is:

1. A voltage regulator circuit, comprising:
at least one coil disposed around a rotor coupled to a first rectifier;
the coils comprise an electric tap connected to a second rectifier;
the first rectifier and second rectifier are coupled to each other with at least one switch; and
the second rectifier is connected to a common load and the first rectifier is connected to the load via the at least one switch.

2. The circuit of claim 1, wherein the circuit is a generator.

3. The circuit of claim 1, wherein the rotor comprises a magnet.

4. The circuit of claim 2, wherein the generator is a multiple phase generator.

5. The circuit of claim 4, wherein each of the coils in the multiple phase generator is connected to the electrical tap.

6. The circuit of claim 4, wherein the electrical tap connects to the coils of the multiple phase generators at different lengths measured from a junction of the coils.

7. The circuit of claim 4, wherein the electrical tap electrically connects to all of the phase at a junction of the phases.

8. The circuit of claim 2, wherein the generator is an alternator.

9. The circuit of claim 2, wherein the generator is an induction generator.

10. The circuit of claim 1, wherein a second electrical tap connects the coil to a third rectifier, the third rectifier being in electrical communication with the load via another electrical switch.

11. The circuit of claim 1, wherein the circuit is a motor.

12. The circuit of claim 1, wherein at least one of the electrical taps comprises a center tap.

13. A turbine driven voltage regulator circuit, comprising:
at least one coil disposed around a rotor coupled to a first rectifier;
the rotor being in mechanical communication with a turbine;
the coil comprises an electric tap connected to a second rectifier;
the first rectifier and second rectifier are coupled to each other with at least one switch; and
the second rectifier is connected to a common load, and the first rectifier is connected to the load via at least one switch.

14. The circuit of claim 13, wherein the turbine is a drilling fluid driven turbine disposed within a bore of a downhole tool string.

15. The circuit of claim 13, wherein the turbine is incorporated into a wind mill.

16. The circuit of claim 13, wherein the turbine is incorporated into a hydroelectric plant.

17. An apparatus for controlling voltage, comprising:
at least one coil disposed around a rotor coupled to a first rectifier;
the rotor being in mechanical communication with a tire assembly;
the coil comprises an electric tap connected to a second rectifier;
the first rectifier and second rectifier are coupled to each other with at least one switch;
the second rectifier is connected to a common load, and the first rectifier is connected to the load via the at least one switch.

18. The apparatus of claim 17, wherein the rotor is also in mechanical communication with an engine assembly.

19. The apparatus of claim 17, wherein the apparatus is incorporated into a braking system.

20. The apparatus of claim 19, wherein the braking system is a regenerative braking system.
